(19) United States
(12) Patent Application Publication
(10) Pub. No.: US 2023/0105256 A1
(43) Pub. Date: Apr. 6, 2023

(54) HYBRID MAGNETIC AND OPTICAL SENSOR APPARATUSES AND METHODS FOR GAMING MACHINE ROTATING ELEMENTS

(71) Applicant: Everi Games Inc., Austin, TX (US)

(72) Inventors: Lawrence J. Knipp, Austin, TX (US); Henry McDonald, Leander, TX (US)

(73) Assignee: Everi Games Inc., Austin, TX (US)

(21) Appl. No.: 17/900,841

(22) Filed: Aug. 31, 2022

Related U.S. Application Data
(60) Provisional application No. 63/253,127, filed on Oct. 6, 2021.

(51) Int. Cl. G01D 5/14; G01D 5/26

(52) U.S. Cl. CPC G01D 5/14; G01D 5/26

(57) ABSTRACT

A rotatable element sensor arrangement includes a home position sensor, magnetic field-type rotation sensor arrangement, and sensor arrangement controller. The home position sensor produces a home position signal in response to a sensor position alignment with a home position feature as the rotatable element rotates about an axis of rotation. The home position feature is at a known angular orientation on the rotatable element relative to game symbol positions of the rotatable element, while the sensor position is located at a known angular orientation relative to a stationary evaluation position. The magnetic field-type rotation sensor arrangement produces a rotation signal to provide an indication of rotational angle of the rotating element along each rotation. The sensor arrangement controller receives the home position signal and rotation signal and produces a sensor arrangement output indicative of a position of the series of game symbol positions relative to the evaluation position.

### CROSS-REFERENCE TO RELATED APPLICATION

The Applicant claims the benefit, under 35 U.S.C. § 119(e), of U.S. Provisional Patent Application No. 63/253,127 filed Oct. 6, 2021, and entitled “Hybrid Magnetic and Optical Sensor Apparatuses and Methods for Gaming Machine Rotating Elements.” The entire content of this provisional application is incorporated herein by this reference.

### TECHNICAL FIELD OF THE INVENTION

The invention relates to gaming machines including one or more mechanical rotating elements, and, more particularly, to a hybrid sensor arrangement for providing rotational position information for such rotating elements to other gaming machine components.

### BACKGROUND OF THE INVENTION

Gaming machines commonly referred to as “slot machines” may include one or more mechanical rotating elements such as physical reels used to form a matrix of symbol locations. The reels carry game symbols on their periphery and the rotational position of the reels determine the game symbols that line up along one or more paylines defined across the matrix of symbol locations for a given play in the game to indicate the result of the play, some prize or a loss. Other rotating elements such as prize-indicating wheels may also be included to communicate the result (or a portion of the result) of a play to the player.

Generally, gaming machines that show results by either mechanical rotating elements or video representations of such elements may operate in either a prize-first process or a reels-first process. In the latter processes, the reels and/or other rotating elements are caused to rotate and then each stop at a randomly or pseudo-randomly selected rotational position to show the player the result of the play by the game symbols lined up along the payline(s) at the those “randomly” determined rotational positions. In a prize-first process, a prize may be randomly or pseudo-randomly determined and then the gaming machine may control the rotating elements to each stop at a respective position to show the prize (or portion thereof in certain game mechanics). In either the prize-first process or reels-first process, it is necessary to detect the rotational position (angular orientation) of each rotating element in the stopped position because that position dictates the game symbol displayed to the player and thus the game result communicated to the player by the alignment of game symbols.

Early mechanical slot machines used mechanical arrangements for detecting the rotational position of each rotatable element. Modern gaming machines use electronic or photoelectronic systems to detect the rotational position of a rotatable element such as a reel, either for determining when the rotatable element must stop to show the desired symbol or for detecting the stop position of the rotatable element and thus the game symbol or symbols displayed by that rotatable element. Modern gaming machines also commonly use a stepper motor for each rotatable element in order to drive the respective element in discrete angular steps.

Historically, suitable light producing devices such as LEDs coupled with photoelectric detectors (photodetectors) have been used to sense the rotational position of a respective rotatable element. This type of setup requires the use of notches in the hub of the rotatable element which allow the photosensor to produce a desired output signal when the notch is aligned with the LED and provide a signal to the control computer that the rotatable element is in a known reference position. Typically, there are two photodetectors used—one which is used to set a “home” position, which would be triggered once every rotation (360 degrees) via a single deep (radially deep) notch in the hub of the reel, and one which is used to set a ‘wedge’ position, which would be triggered every 15 degrees (for a 24 slice wedge, other combinations are also used) via multiple shallow (radially shallow) notches set in the hub of the rotatable element. As the hub rotates, the sensors are triggered and produce the desired output when the respective slot permits an opening to allow the light from the LED to reach the photodetector. It is also possible to use reflective/non-reflective elements on the hub of the rotatable element so that the light source and photosensor may be positioned on the same side of the rotatable element.

Alternatively to photosensor arrangements, rotating magnetic sensor arrangements can be used to detect the rotational position of a rotatable element. Such rotating magnetic sensor arrangements may include a device that puts out some signal representative of an electromagnetic parameter that varies with the angular orientation of the rotatable element being sensed. These magnetic sensor arrangements have historically required a calibration of the home position. Such calibration was accomplished by using equipment external to the magnetic sensor and gaming machine to monitor the position of the rotatable element, then a controller/processing device wrote a signal to a controller of the magnetic sensor arrangement to identify this home position. If the assembly was ever disassembled and/or changed, this calibration process had to be repeated. Some magnetic sensor arrangements could only be written to once in the calibration process and thus if calibration was again required the device had to be discarded and a new one installed. Thus these types of rotating magnetic sensor arrangements not only increased downtime in view of the special calibration requirement, but also required replacement parts in the event recalibration was required after the initial calibration.

### SUMMARY OF THE INVENTION

An object of the present invention is to provide rotatable element sensor arrangements that overcome the above-noted problems and others associated with sensors for detecting the rotational position of a rotatable element such as a rotatable reel or wheel in a gaming machine. Other objects of the present invention include providing gaming machine employing such an improved rotatable element sensor arrangement and methods of detecting the rotational position of a rotatable element about an axis of rotation.

A rotatable element sensor arrangement according to a first aspect of the present invention includes a home position sensor, a magnetic field-type rotation sensor arrangement, and a sensor arrangement controller. The home position sensor is operable for producing a home position signal in response to a sensor position alignment with a home position feature as the rotatable element rotates about an axis of rotation. The home position feature is located at a known angular orientation on the rotatable element relative to a series of game symbol positions along a periphery of the rotatable element. The sensor position is located at a known angular orientation relative to an evaluation position that is stationary with respect to the rotatable element. The magnetic field-type rotation sensor arrangement is operable for producing a rotation signal over the course of each rotation of the rotatable element about the axis of rotation. This rotation signal provides an indication of rotational angle of the rotating element at a defined resolution along each rotation of the rotatable element. The sensor arrangement controller is operably connected to receive the home position signal and the rotation signal and produce a sensor arrangement output indicative of a position of the series of game symbol positions relative to the evaluation position.

The present invention employs a hybrid approach in which the home position sensor is used to detect the home position signal and a magnetic sensor is used to detect the rotation angle (between zero and 360 degrees) from the home position signal. This arrangement does not require any additional, external hardware or software or computer equipment to achieve calibration. The arrangement of home position sensor and magnetic sensor also allows for flexible in-field modification of the rotatable element (reel and wheel) setups without major operator intervention.

A gaming machining according to a second aspect of the invention incorporates the home position sensor, magnetic field-type rotation sensor arrangement, and sensor arrangement controller according to the first aspect of the invention. Such a gaming machine includes a game processor, a motor controller, and a rotatable element and motor assembly including a rotatable element and a motor for rotating the rotatable element about an axis of rotation. The rotatable element has a series of game symbol positions defined along a periphery thereof and the motor is operable for, in response to a motor control signal, rotating the rotatable element from a first stop position about the axis of rotation through a number of rotations about the axis of rotation to a second stop position about the axis of rotation. The motor controller is operable to communicate the motor control signal to the motor in response to a signal from the game processor.

A third aspect of the invention encompasses methods of detecting the rotational position of a rotatable element about an axis of rotation. Methods according to this third aspect of the invention include producing a home position signal in response to a sensor position alignment with a home position feature as the rotatable element rotates about an axis of rotation. The home position feature is located at a known rotational position relative to a series of game symbol positions along the periphery of the rotatable element and the sensor position is located at a known angular orientation to an evaluation position that is stationary with respect to the rotatable element. Methods according to this third aspect of the invention further include sensing the magnetic field of a magnet mounted on the rotatable element to produce a rotation signal over the course of each rotation of the rotatable element about the axis of rotation. This rotation signal provides an indication of rotational angle of the rotating element at a defined resolution along each rotation of the rotatable element. These methods further include defining a home angular orientation of the rotatable element in response to the home position signal and determining a displacement from the home angular orientation from the rotation signal to determine the rotational position of the rotatable element about the axis of rotation relative to the evaluation position.

In each of the aspects of the invention the home position sensor may comprise a photodetector system and the home position signal may comprise an electrical signal pulse output from a photodetector of the photodetector system. The electrical signal pulse may be produced in response to a detected light signal from a light source included in the photodetector system or an external light source. The rotation signal may be produced by sensing a magnetic field of a magnet that is attached to the rotatable element so as to rotate with the rotatable element about the axis of rotation. The rotation signal may comprise an analog signal or may comprise one or more voltage pulses or a digital signal produced from an analog signal generated by sensing the magnetic field.

These and other aspects, advantages, and features of the invention will be apparent from the following description of representative embodiments, considered along with the accompanying drawings.

### BRIEF DESCRIPTION OF THE DRAWINGS

FIG. 1 is isometric rear view of a rotatable element assembly, in this case comprising a gaming machine reel assembly.

FIG. 2 is a schematic representation of a gaming machine having a rotatable element rotation position detector arrangement in accordance with an embodiment of the present invention.

FIG. 3 is a representation of a reel strip that may be used with the reel assembly shown in FIG. 1.

FIG. 4 is a schematic side view of a reel cage that may be used in connection with the reel strip shown in FIG. 3 and as part of each reel/motor assembly shown in FIG. 2. The side view of FIG. 4 shows the side of the reel cage assembly facing a bracket of the reel/motor assembly such as the bracket shown in FIG. 1.

FIG. 5 is a front view of the reel cage shown in FIG. 4 perpendicular to the cage assembly rotational axis and with the reel strip of FIG. 3 installed thereon, but broken away on both sides of reel symbol “E” to show the underlying cage structure.

FIG. 6 is a front isometric view of a gaming machine with rotatable reels that may each have a reel sensor arrangement as shown in FIG. 2.

FIG. 7 is a front view of a portion of a gaming machine having a rotatable wheel that may have a sensor arrangement in accordance with aspects of the present invention.

FIG. 8 is a flow diagram showing process steps in accordance with the present invention.

### DESCRIPTION OF REPRESENTATIVE EMBODIMENTS

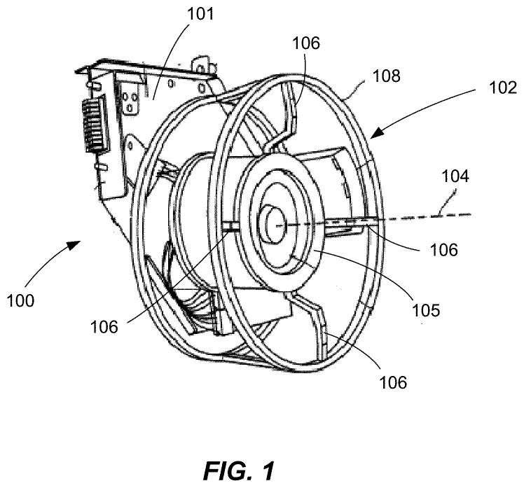

A rotatable element sensor arrangement in accordance with the present invention may be used to detect the rotational position of a gaming machine reel such as the reel included in the reel assembly 100 shown in FIG. 1. This example reel assembly 100 includes a mounting bracket 101 that supports a reel cage 102 on which a reel symbol strip (not shown in FIG. 1) may be mounted to define the gaming machine reel. Reel cage 102 is mounted for rotation on bracket 101 about a rotational axis 104, and includes a hub 105, spokes 106, and a rim 108 on which a reel symbol strip may be secured. A motor for rotating the reel cage 102 may be mounted on the bracket 101 and housed within hub 105 (and thus concealed in the view of FIG. 1). The motor may comprise a stepper motor that receives a drive signal from a motor driver circuit under the control of a suitable motor controller which may include a microprocessor.

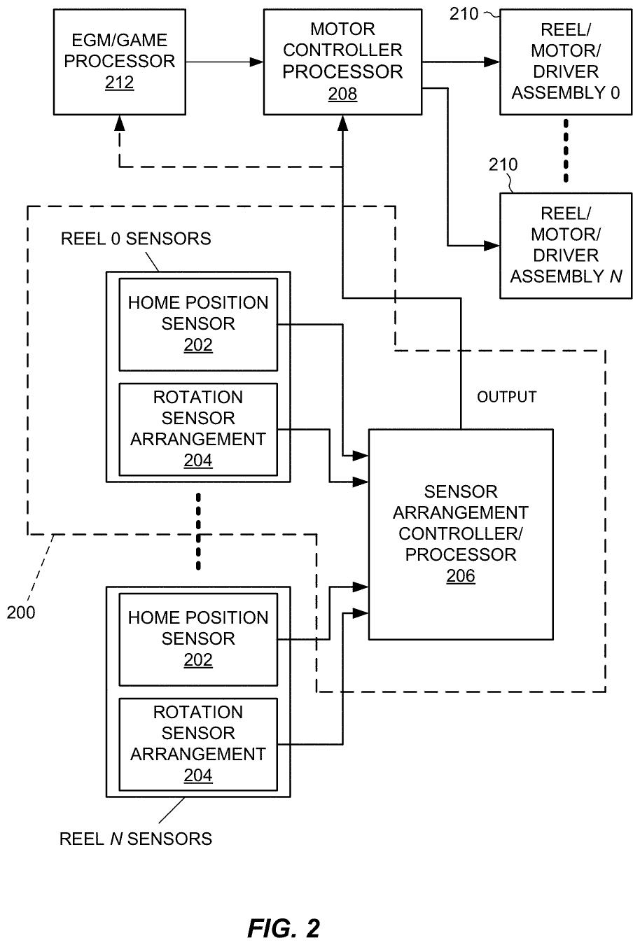

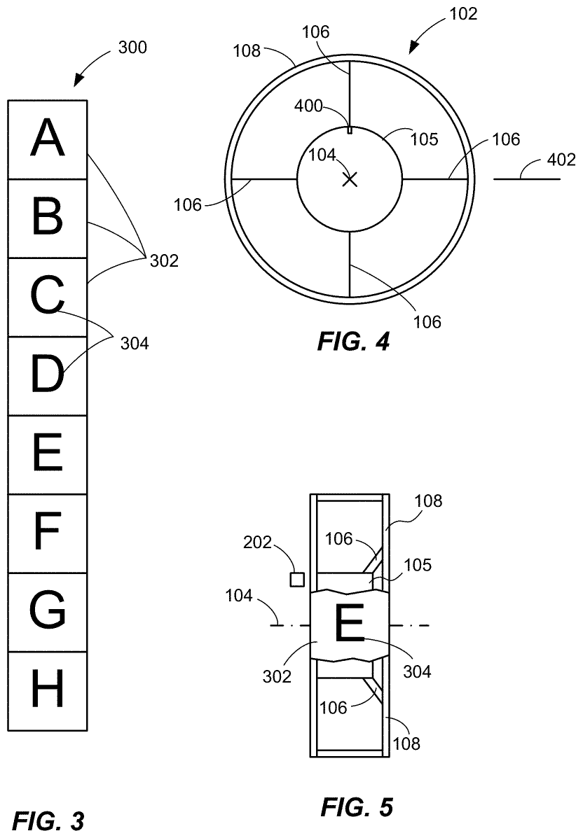

Referring to FIG. 2, a rotatable element sensor arrangement 200 according to one aspect of the invention includes a home position sensor 202, a magnetic field-type rotation sensor arrangement 204, and a sensor arrangement controller 206. The home position sensor 202 is operable for producing a home position signal in response to a sensor position alignment with a home position feature as the rotatable element rotates about an axis of rotation. The sensor position is at a known angular orientation relative to an evaluation position (which may be a payline position) that is stationary with respect to the rotatable element. An example home position feature will be described in reference to FIG. 4 but is not shown in FIG. 2. The home position feature is located at a known rotational position relative to a series of game symbol positions along a periphery of the rotatable element. FIG. 3 shows an example game symbol strip 300 defining such a series of game symbol positions 302, each with a respective game symbol 304 represented by alphabetic characters in the example. The magnetic field-type rotation sensor arrangement 204 is operable for producing a rotation signal over the course of each rotation of the rotatable element (such as a reel defined by reel cage 102 in FIG. 1) about the axis of rotation. This rotation signal provides an indication of rotational angle of the rotating element at a defined resolution along each rotation of the rotatable element. The sensor arrangement controller 206 is operably connected to receive the home position signal and the rotation signal and produce a sensor arrangement output indicative of a position along the series of game symbol positions 302 such as those shown in the example reel symbol strip 300 shown in FIG. 3 relative to the evaluation position.

The example arrangement shown in FIG. 2 includes a separate set of home position sensor 202 and rotation sensor arrangement 204 for each rotatable element for which the rotational position is to be determined. Two or more of these sets of home position sensor 202 and rotation sensor arrangement 204 may send their respective outputs to a single sensor arrangement controller/processor 206 as shown in FIG. 2. Alternatively, one or more of the sets of home position sensor 202 and rotation sensor arrangement 204 in a given gaming machine may have its own dedicated sensor arrangement controller/processor.

FIG. 2 shows multiple reel/motor/driver assemblies 210. Each of these assemblies may be similar to the reel assembly 100 shown in FIG. 1. Each assembly 210 includes a rotatable element comprising a reel in this case, a motor, and a motor drive circuit. The motor drive circuit of the respective assembly is operable under the control of processor 208 to rotate the respective reel about its rotational axis through a number of rotations and then come to a stop at a desired stop position. FIG. 2 also shows an EGM/Game processor 212 that may comprise a processor programmed to provide overall control of the gaming machine to provide various games that show game play results via the rotating elements, that is, reels in this example.

The output from the sensor arrangement controller/processor 206, or each such sensor arrangement controller/processor where multiple such elements are included in a given implementation, is communicated to other elements of the gaming machine for use in accordance with the operation of the gaming machine. In a prize-first implementation, the output of controller processor 206 may be directed to a motor controller processor 208 of the gaming machine for use in verifying that the stop position selected to show the result/prize for the activation of the gaming machine corresponds to the stop position/rotational position sensed by the sensor arrangement for the given rotatable element. In a reels-first implementation where the reels are randomly stopped to show a result in the game, the output of controller processor 206 may be directed to EGM/game processor 212 so that processor may identify any prize associated with the stop positions of the various reels.

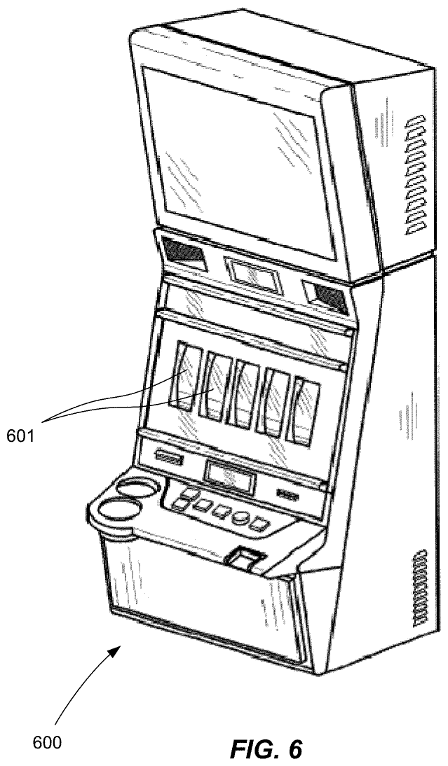

FIG. 4 shows a schematic side view of the reel cage 102 shown in the example reel assembly 100 of FIG. 1. In this orientation, the rotational axis 104 of the reel cage 102 extends perpendicular to the drawing sheet. The example of FIG. 4 shows a home position feature 400 comprising an open slot in a rim/flange of hub 105. As shown in FIG. 5, the home position sensor 202 is positioned at a radial distance from the axis of rotation 104 to produce a home position signal as the home position feature 400 passes the home position sensor 202 as the reel cage is rotated about axis 104. Thus in this example, the home position sensor arrangement may include a photosensor positioned at 202 in FIG. 5 and a suitable light source positioned on the opposite side of the slot-type home position feature. Alternative arrangements for the home position sensor may include a light source and photosensor facing the same direction and the home position feature may comprise a reflective strip that reflects light to the photosensor to cause the photosensor to produce a signal as the reflective strip passes. In any case, the position of the sensor is located at a known angular orientation to an evaluation position that is stationary with respect to the rotatable element. If the sensor 202 is positioned in the reel assembly so as to align with the home position feature 400 in the position of FIG. 4, the sensor position would be at an angle of 90 degrees to the evaluation position shown at 402 in FIG. 4.

It will be appreciated that a game symbol strip such as strip 300 in FIG. 3 may be wrapped around the rim 108 of reel cage 102 to provide a series of game symbol positions 302 that rotate with the cage 102. The game symbol strip may be connected to the reel cage 102 so that a known position on the game symbol strip aligns with the home position feature. This relationship between the game symbol strip and the home position feature together with the sensor position at a known angle to the evaluation position together allow the rotation signal to be employed to produce the sensor arrangement output indicative of a position of the series of game symbol positions relative to the evaluation position.

The rotation signal may be produced by any suitable magnetic field-type rotation sensor. For example, the rotation signal may be produced by sensing a magnetic field of a magnet that is attached to the rotatable element so as to rotate with the rotatable element about the axis of rotation. The magnetic field sensor arrangement may comprise an arrangement of Hall effect sensors for example. The invention is also not limited to any particular form of the rotation signal. For example, the signal communicated to the sensor arrangement controller/processor 206 may comprise an analog signal such as a voltage signal that is dependent upon the angular orientation of the rotatable element and magnet connected thereto. Alternatively, the signal output from the field sensor arrangement may be a pulse train, that is, a series of pulses that are generated in dependence on the rotation of the rotatable element and produced at a defined resolution. For example, some implementations of the field sensor arrangement may output a signal in the form of a series of pulses where one pulse is produced for each X degrees of rotation of the rotatable element (one pulse per each one-tenth degree of rotation as a specific example). In this case, the controller/processor 206 may be adapted to count pulses received from sensor arrangement 204 after receipt of the home position signal to produce the sensor output indicative of the position along the series of game symbols relative to the evaluation position. In other implementations, the field sensor arrangement may output a signal in the form of pulses in which the pulse width relates to a given amount of rotation. For example, a 1 μs pulse width might indicate 0.1 degree of rotation, a 2 μs pulse width might indicate 0.2 degree of rotation, and so forth. In these implementations a single pulse may be produced to indicate the amount of rotation. In yet further implementations, the field sensor arrangement may be configured to output a signal in the form of a data packet containing rotation information.

It will be appreciated that the various processing steps described above in connection with the controllers or processors shown in FIG. 2 may be divided in any suitable fashion amongst physical processing devices. For example, the processing performed by controller/processor 206 may be performed by the motor controller processor or elsewhere.

It will also be appreciated that sensors other than optical-type sensors may be used to provide the home position signal.

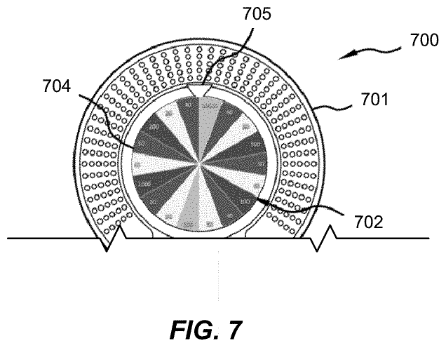

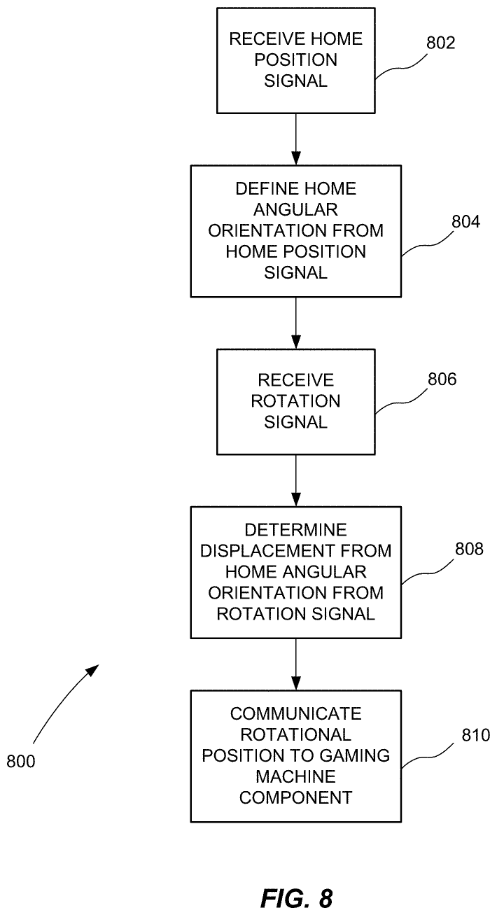

FIG. 6 shows a gaming machine 600 in which a rotatable element sensor arrangement according to the present invention may be used. Gaming machine 600 includes five rotatable reels 601 each of which may employ a rotatable element sensor arrangement as described above. FIG. 7 shows a portion of another example gaming machine 700 including a cabinet portion 701 housing a wheel 702 showing wheel segments 704 and being rotatable with respect to a pointer 705. In this example, rotatable wheel 702 may be associated with a rotatable element sensor arrangement as described above in connection with FIGS. 1-5. The wheel segments 704 in the example of FIG. 7 correspond to the game symbol positions 302 shown in the reel strip example of FIG. 3, and the rotatable element sensor arrangement is operable to produce a sensor arrangement output indicative of a position of the series of wheel segments 704 relative to an evaluation position which may be taken as the position of pointer 705.

FIG. 8 shows a process 800 that may be performed by the controller/processor 206 shown for example in FIG. 2. The home position signal is produced as described above by the home position sensor 202 in FIG. 2 and received at controller/processor 206 as indicated at process block 802. The method includes defining a home angular orientation of the rotatable element in response to the home position signal as shown at 804. Since the game symbol location aligning with the home position symbol is known and since the angular position of the sensor 202 relative to the evaluation position (402 in FIG. 4) is known, the point along the series of symbol positions that aligns with the evaluation position at the time the home position signal is received is also known. The rotation signal received at 806 may then be used as indicated at 808 to determine the angular displacement from the home angular orientation until the reel comes to rest. The resulting rotational position information when the reel comes to rest may then be communicated to the appropriate gaming machine component as shown at 810.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of the invention, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A rotatable element sensor arrangement for use in detecting a rotational position of a rotatable element in a gaming machine, the rotatable element sensor arrangement including:
(a) a home position sensor operable for producing a home position signal in response to alignment of a sensor position with a home position feature as the rotatable element rotates about an axis of rotation, the home position feature being located at a known angular orientation on the rotatable element relative to a series of game symbol positions along a periphery of the rotatable element and the sensor position being at a known angular orientation relative to an evaluation position that is stationary with respect to the rotatable element;
(b) a magnetic field-type rotation sensor arrangement operable for producing a rotation signal over the course of each rotation of the rotatable element about the axis of rotation, the rotation signal providing an indication of rotational angle of the rotating element at a defined resolution along each rotation of the rotatable element; and
(c) a sensor arrangement controller operably connected to receive the home position signal and the rotation signal and produce a sensor arrangement output indicative of a position of the series of game symbol positions relative to the evaluation position.

2. The rotatable element sensor arrangement of claim 1 wherein the home position sensor is a photodetector system and the home position signal is an electrical signal pulse from a photodetector of the photodetector system.

3. The rotatable element sensor arrangement of claim 2 wherein the electrical signal pulse is produced in response to a detected light signal from a light source included in the photodetector system.

4. The rotatable element sensor arrangement of claim 2 wherein the rotation signal is produced by sensing a magnetic field of a magnet that is attached to the rotatable element so as to rotate with the rotatable element about the axis of rotation.

5. The rotatable element sensor arrangement of claim 4 wherein the rotation signal comprises an analog signal.

6. The rotatable element sensor arrangement of claim 4 wherein the rotation signal comprises one or more voltage pulses.

7. The rotatable element sensor arrangement of claim 4 wherein the rotation signal comprises a digital signal.

8. A gaming machine including:
(a) a game processor;
(b) an assembly including a rotatable element and a motor, the rotatable element including a series of game symbol positions defined along a periphery thereof and the motor being operable for, in response to a motor control signal, rotating the rotatable element from a first stop position through a number of rotations about an axis of rotation and to a second stop position about the axis of rotation;
(c) a motor controller operable to communicate the motor control signal to the motor in response to a signal from the game processor;
(d) a home position sensor operable for producing a home position signal in response to alignment of a sensor position with a home position feature as the rotatable element rotates about the axis of rotation, the home position feature being located at a known angular orientation on the rotatable element relative to the series of game symbol positions and the sensor position being at a known angular orientation relative to an evaluation position that is stationary with respect to the rotatable element;
(e) a magnetic field-type rotation sensor arrangement operable for producing a rotation signal over the course of each rotation of the rotatable element about the axis of rotation, the rotation signal providing an indication of rotational angle of the rotating element at a defined resolution along each rotation of the rotatable element; and
(f) a sensor arrangement controller operably connected to receive the home position signal and the rotation signal and produce a sensor arrangement output to the motor controller, the sensor arrangement output being indicative of a respective one of the series of game symbol positions aligned with the evaluation position when the rotatable element is in the second stop position.

9. The gaming machine of claim 8 wherein the second stop position is randomly selected.

10. The gaming machine of claim 8 wherein the home position sensor is a photodetector system and the home position signal is an electrical signal pulse from a photodetector of the photodetector system.

11. The gaming machine of claim 10 wherein the electrical signal pulse is produced in response to a detected light signal from a light source included in the photodetector system.

12. The gaming machine of claim 10 wherein the rotation signal is produced by sensing a magnetic field of a magnet that is attached to the rotatable element so as to rotate with the rotatable element about the axis of rotation.

13. The gaming machine of claim 12 wherein the rotation signal comprises an analog signal.

14. The gaming machine of claim 12 wherein the rotation signal comprises one or more voltage pulses.

15. The gaming machine of claim 12 wherein the rotation signal comprises a digital signal.

16. A method of detecting a rotational position of a rotatable element about an axis of rotation, the method including:
(a) producing a home position signal in response to alignment of a sensor position with a home position feature as the rotatable element rotates about an axis of rotation, the home position feature being located at a known rotational position relative to a series of game symbol positions along a periphery of the rotatable element and the sensor position being at a known angular orientation to an evaluation position that is stationary with respect to the rotatable element;
(b) sensing the magnetic field of a magnet mounted on the rotatable element and rotating therewith about the axis of rotation to produce a rotation signal over the course of each rotation of the rotatable element about the axis of rotation, the rotation signal providing an indication of rotational angle of the rotating element at a defined resolution along each rotation of the rotatable element; and
(c) defining a home angular orientation of the rotatable element in response to the home position signal and determining a displacement from the home angular orientation from the rotation signal to determine the rotational position of the rotatable element about the axis of rotation relative to the evaluation position.

17. The method of claim 16 wherein producing the home position signal includes producing an electrical signal pulse output from a photodetector.

18. The method of claim 16 wherein the rotation signal comprises an analog signal.

19. The method of claim 16 wherein the rotation signal comprises one or more voltage pulses.

20. The method of claim 16 wherein the rotation signal comprises a digital signal.
